(19) United States
(12) Patent Application Publication
(10) Pub. No.: US 2024/0313336 A1
(43) Pub. Date: Sep. 19, 2024

(54) ENERGY STORAGE VENTING DEVICE

(71) Applicant: Airbus (S.A.S.), Blagnac (FR)

(72) Inventor: Sasank KOMARLA, Bristol (GB)

(21) Appl. No.: 18/586,211

(22) Filed: Feb. 23, 2024

(30) Foreign Application Priority Data
Mar. 15, 2023 (IN) 202311017467

(51) Int. Cl. H01M 50/342; F16K 17/40; H01M 50/358

(52) U.S. Cl. CPC H01M 50/3425; F16K 17/403; H01M 50/358; H01M 2220/20

(57) ABSTRACT

A venting device 9a to 9c for a battery 6a including a burst disc 13; a fluid flow path including first and second outlet ducts 14, 15; a flexible coupling 16 around a junction between the first and second outlet ducts; and a piston seal 17 between one of the outlet ducts and the flexible coupling. The piston seal 17 and the flexible coupling 16 provide an expansion cavity 22 for gases exiting the burst disc. The flexible coupling 16 includes an elastomeric tube 20 arranged to expand as the device reacts to a shock wave and returns to normal dimensions.

### RELATED APPLICATION

This application incorporates by reference and claims priority to India patent application IN 202311017467, filed Mar. 15, 2023.

### FIELD OF TECHNOLOGY

This invention relates to a venting device for an energy storage system such as a battery or system of batteries. The invention further relates to an energy storage system including such a venting device, and to a vehicle including such a venting device and/or energy storage system, such as an aircraft.

### BACKGROUND

An aircraft conventionally includes an electrical system arranged to energize various devices on the aircraft, such as flight instruments, navigation aids, cabin heating and lighting. An aircraft's electrical system typically includes one or more batteries arranged to store electrical energy. Previously, lead-acid or Nickel-Cadmium batteries were employed, but there has recently been a move towards Lithium ion batteries, which are rechargeable and dependable. A typical aircraft battery installation comprises groups of cells contained in one or more enclosures or modules.

A problem which may be encountered with aircraft batteries is that, if the battery deteriorates, hot gases can be emitted which must be evacuated to the environment outside of the aircraft. To this end, a venting system is provided between the, or each, battery pack and a vent on the exterior surface of the vehicle.

It has been proposed to utilize a burst disc (also known as a rupture disc) as a pressure relief safety valve. The burst disc is arranged to rupture when the pressure inside a battery module increases beyond a predetermined threshold. It has been found that the hot and high pressure exhaust flow from a ruptured disc has a Mach number which is close to 1, i.e. close to the speed of sound. This can cause a shock wave to be generated in the venting system. Such shock waves can change the properties of the fluid flow in the venting system, causing abrupt changes in temperature, pressure and density. Furthermore, in order to withstand this excess pressure, the venting system is typically made to be very strong and relatively heavy, which is detrimental from the point of view of fuel consumption for the aircraft.

It has been proposed to use a combination of a burst disc with a bellows-type expansion joint downstream of the burst disc. The expansion joint is arranged to absorb the shock wave from the flow emerging from the burst disc. However, it has been found that the corrugated interior surface of the bellows has the capability to cause complicated shock patterns having very strong areas of compression, resulting in increased turbulence, excessive vibration, noise and flow related losses due to the high speed flow over a wavy surface.

### SUMMARY OF THE TECHNOLOGY

The invention may be embodied as a venting device for an energy storage system, comprising: a burst disc; a fluid flow path including first and second outlet ducts; a flexible coupling around a junction between the outlet ducts; and a piston seal between an outlet duct and the flexible coupling. The provision of a flexible coupling allows for shock waves to be absorbed or dampened. The flexible coupling is located external to the outlet ducts and so the flexible coupling has low impact on the linearity of the fluid flow emerging from the burst disc.

The piston seal and the flexible coupling may be arranged to provide an expansion cavity for gases exiting the burst disc. Shock waves produced by the gases interact with the flexible coupling by means of the expansion cavity.

Part of the flexible coupling and the piston seal may be capable of relative sliding movement. Such sliding movement assists the venting device in absorbing shock waves.

The flexible coupling may include first and second rigid structural members associated with the respective outlet ducts and a flexible sleeve between the rigid structural members. The rigid structural members provide strength and rigidity to the flexible coupling whilst the flexible sleeve accommodates the movement required to absorb the shock waves.

The flexible sleeve may comprise a tube of elastomeric material. Alternatively, the flexible sleeve may comprise a bellows duct. Each of these types of sleeve is capable of returning the flexible coupling to its original position after it has absorbed a shock wave.

One of the structural members may be arranged to be capable of sliding movement with respect to the outlet ducts.

The piston seal may be attached to the first outlet duct and is arranged to make sliding contact with the second structural member.

The outlet ducts may be arranged along a common axis, with the flexible coupling being arranged coaxially around the ducts.

The energy storage system may include a housing having an outlet to the burst disc.

The invention may be embodied to provide an energy storage system comprising at least one battery in a housing and a venting device constructed according to the first aspect of the invention. Preferably, a plurality of batteries is provided in a plurality of housings, with each housing being associated with a venting device constructed according to the first aspect of the invention.

The invention may be embodied to provide a vehicle including such an energy storage system.

A venting system may be provided comprising at least one duct between the, or each, venting device and an exterior surface of the vehicle. The vehicle may take the form of an aircraft.

### BRIEF DESCRIPTION OF THE DRAWINGS

The invention will now be described, by way of example, with reference to the accompanying drawings in which:

FIG. 1 is a side view of an aircraft including an energy storage venting system constructed according to an embodiment of the invention;

FIG. 2 is a schematic diagram of the venting system of FIG. 1;

FIG. 3 is a schematic diagram of a venting device of the venting system of FIGS. 1 and 2; and

FIG. 4 is a schematic diagram of an alternative embodiment of a venting device of the venting system of FIGS. 1 and 2.

### DETAILED DESCRIPTION

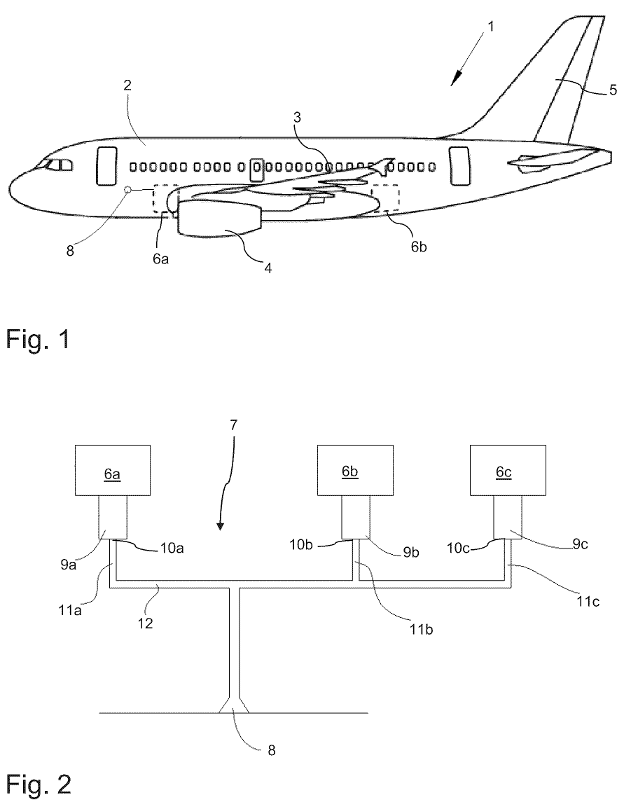

With reference to FIG. 1, an aircraft in the form of a typical transonic commercial passenger airplane 1. The aircraft 1 comprises a fuselage 2, wings 3, main engines 4 and a tail 5. The aircraft 1 further contains within it an energy storage system. The energy storage system comprises a plurality of battery packs, two of which 6a, 6b are shown in broken lines in FIG. 1. Each battery pack 6a, 6b comprises a housing containing at least one battery or cell, for example a lithium-ion battery. The batteries are arranged to provide electrical power to devices on the aircraft through electrical conductors (not shown) running between the battery packs 6a, 6b and the electrical devices.

In the event of deterioration of one or more of the batteries, a venting system 7 is provided for the removal of gases. The general layout of an example venting system 7 is shown in FIG. 2. The venting system 7 is arranged to fluidly connect the energy storage system to the ambient environment via an exit port 8 in the outer skin of the aircraft.

With reference to FIG. 2, the energy storage system comprises a plurality of battery packs 6a-6c, including the two packs 6a, 6b shown in FIG. 1. Of course, any number of battery packs 6 could be provided. Each battery pack 6a-6c is fluidly connected to the venting system 7 via a venting device 9a-9c, which will be described in more detail later in this specification. The respective outlets 10a-10c of each venting device are connected to respective exhaust ducts, e.g., pipes 11a to 11c. The exhaust ducts 11a to 11c are fluidly connected to a main line 12 that is also connected to the exit port 8 arranged through the outer skin of the aircraft 1. Thus, any gasses emitted by one or more of the batteries can be vented to the atmosphere through the system of ducts 11a to 11c and 12.

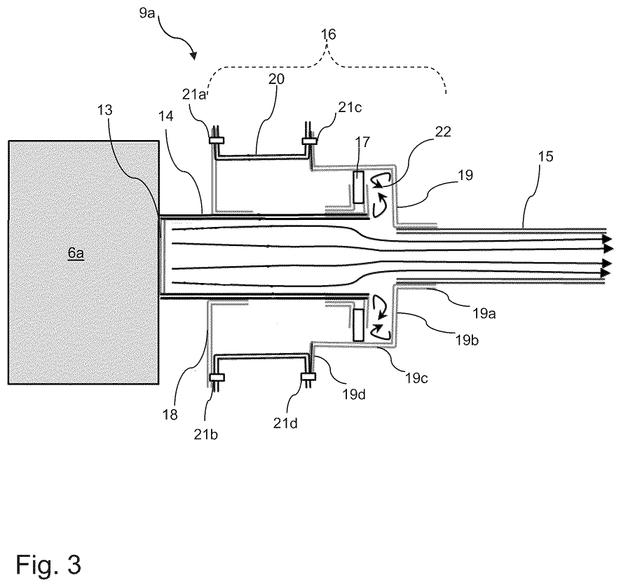

Deterioration of a battery can also result in the generation of excess pressure, which can propagate through the venting system 7. In order to prevent such propagation, each battery pack 6a-6c is associated with a venting device 9a-9c constructed according to the invention, an example of which is shown in FIG. 3.

The venting device 9a may include: a burst disc 13; a first outlet duct 14 immediately downstream of the burst disc; a second outlet duct 15, coaxial with and downstream of the first duct 14; a flexible coupling 16 arranged around the junction of the ducts 14, 15; and a piston seal 17 arranged between one of the ducts (in this case duct 15) and the flexible coupling 16. In this embodiment, the flexible coupling 16 comprises a structural members 18, 19 arranged around, and coaxial with, the first and second outlet ducts 14, 15; and a flexible sleeve arranged as a bridge between the two structural members 18, 19. The flexible coupling 16 is arranged to form a flexible outer envelope around the junction between the first and second outlet ducts 14, 15.

The first structural member 18 comprises a metallic flange in the form of a collar, with a neck part 18a arranged to fit around the outer circumference of the first outlet duct 14, and a shoulder part 18b that extends radially outwardly. The shoulder part 18b is attached by means of fasteners 21a, 21b to a first end portion of the flexible sleeve.

The flexible sleeve comprises a tube 20 of an elastomeric fabric. The fabric may be formed from a fluoro-elastomer, which is a fluorocarbon-based synthetic rubber. Fluoro-elastomers are typically hard-wearing and resistant to chemicals, heat and abrasion. The other end portion of the elastomeric tube 20 is attached by fasteners 21c, 21d to the second structural member 19. The provision of a simple fastening system facilitates assembly of the venting device, and also disassembly in case of replacement or repair of the flexible coupling 16.

The second structural member 19 comprises a metallic flange having a neck part 19a arranged to fit around the outer circumference of the second outlet duct 15, a shoulder part 19b that extends radially outwardly, a sleeve part 19c that extends along an axis coaxial with the axis of the outlet ducts 14, 15, and a rim part 19d that extends radially outwardly. The rim 19d is the part that that the second end portion of the elastomeric tube 20 is attached to.

The piston seal 17 includes an elastomer ring arranged around the outer circumference of the first outlet duct 14, at the end portion remote from the burst disc 13. The piston seal 17 may be attached directly to the outer surface of the outlet duct 14 or may, as is shown in FIG. 3, be held by a flange-like holder that is fastened or bonded to the end of the outlet duct 14. The piston seal 17 is arranged to make intimate contact with the inner surface of the sleeve part 19c of the second structural member 19. There is an expansion cavity 22 defined by the end face of the seal 17, an end portion of the inner surface of the sleeve part 19c and the shoulder part 19b of the second structural member, the function of which will be discussed below.

A burst disc is a device that is calibrated to rupture when the pressure exerted on it exceeds a predetermined threshold. In this embodiment, the burst disc 13 is arranged to form part of a face of one of the battery pack housings 6a, such as covering an opening in the housing. The mechanical resistance of the burst disc 13 is lower than the mechanical resistance of the other faces of the battery pack 6a to ensure that the burst disc will rupture before any other part of the battery pack housing. Thus, the burst disc 13 provides an outlet for gases when the pressure of those gases inside the battery pack 6a exceeds the predetermined threshold.

When the burst disc 13 ruptures, the outgoing gas flow may be hot and at high pressure, leading to a shock wave being produced. The flexible coupling 16 is arranged to absorb or dampen any shock waves. The shock wave expands into the expansion cavity 22 and causes a pressure thrust against the shoulder 19b of the second structural member 19. The second structural member 19 is arranged to be able to slide over the second outlet duct 15, and the elastomeric tube 20 stretches to accommodate this movement. The relative movement of the second structural member 19 and the outlet duct 15 means that the piston seal slides along the inner surface of the sleeve part 19b of the second structural member 19 as the apparatus absorbs a shock wave. When the shock wave has been absorbed, the second structural member 19 moves back to its original position under a restoring force exerted on it by the elastomeric tube 20.

Only a small portion of the gaseous flow exiting the burst disc 13 is pushed into the expansion cavity 22 by the shock wave. A majority of the flow is smooth and unperturbed, and so the fluid flow exiting the venting device 9a exhibits a smaller amount of turbulence than was achievable hitherto. Hence, the flow of fluid in the venting system 7 is relatively low in turbulence. This means that the ducts 11a to 11c, 12 of the venting system 7 can be made lighter in weight than was possible hitherto.

The flexible coupling 16 and the seal 17 may also advantageously absorb vibration of the venting device 9a during use, which can reduce strain on the venting system 7. The flexible coupling 16 can also absorb thermal expansion and contraction that would be experienced by the venting device 9a during flight. As the fluid exiting the burst disc does not come into contact with the elastomeric tube 20, it does not need to be as resistant to high temperatures and corrosive chemicals as in prior devices where the fluid flow is arranged to flow along a flexible sleeve.

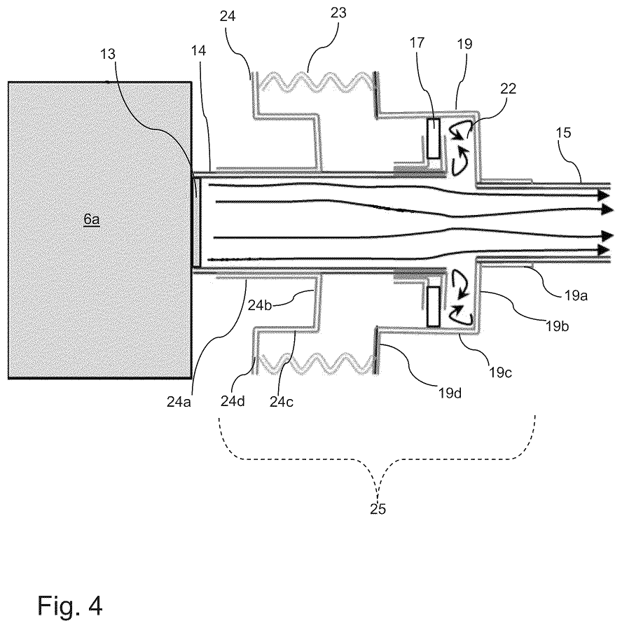

An alternative venting device is shown in FIG. 4. In this embodiment, there is a burst disc 13 and outlet ducts 14, 15 downstream of the burst disc. A flexible coupling 25 is arranged around the junction between the ducts 14, 15. A piston seal 17 is arranged between the first outlet duct 14 and the flexible coupling 25 as before. However, in this embodiment, the flexible sleeve of the flexible coupling takes the form of a bellows duct 23. The bellows duct 23 is a tube that is corrugated along its length, with a plurality of circumferential ridges. The bellows duct 23 could be made of metal, an elastomer or a hard-wearing fabric.

The flexible coupling 25 includes two rigid structural members 24, 19 arranged around the respective outlet ducts 14, 15. The end portions of the bellows duct 23 are connected to respective ones of the structural members 24, 19. The second structural member 19 is the same as that shown in FIG. 3, with a neck part 19a arranged to fit around the outer circumference of the second outlet duct 15, a shoulder part 19b that extends radially outwardly, a sleeve part 19c that extends along an axis coaxial with the axis of the outlet ducts 14, 15, and a rim part 19d that extends radially outwardly. The rim part 19d is attached to an end of the bellows duct 23.

The structural member 24 is arranged around the first outlet duct 14, in a similar way to the structural member 18 of FIG. 3. However, the structural member 24 has a more convoluted shape, with a neck part 24a arranged to fit around the outer circumference of the first outlet duct 14, a shoulder part 24b that extends radially outwardly, a sleeve 24c that extends back around the neck part 24a, and a rim part 24d that extends radially outwardly. The rim part 24d is attached to the other end of the bellows duct 23. The structural member 24 is rigid and able to accommodate strain forces experienced by the venting device in use. The folded shape of the structural member is able to accommodate a longer flexible sleeve than the apparatus of FIG. 3.

The venting device of FIG. 4 operates in a similar way to that of FIG. 3. The hot, high-pressure gas emerging from the burst disc 13 expands into an expansion cavity 22 defined by the end face of the seal 17, an end portion of the inner surface of the sleeve part 19c and the shoulder part 19b of the second structural member. The pressure wave caused by the emerging gas flow causes a pressure thrust against the shoulder 19b of the second structural member 19. The second structural member 19 is arranged to be able to slide over the second outlet duct 15, and the bellows duct 23 expands to accommodate this movement. The relative movement of the second structural member 19 and the outlet duct 15 means that the piston seal 17 slides along the inner surface of the sleeve part 19b of the second structural member 19 as the apparatus absorbs the shock wave. When the shock wave has been dampened or absorbed, the bellows duct 23 retracts and returns the second structural member 19 to its original position.

Variations may be made without departing from the scope of the invention. For example, the invention is applicable to other forms of vehicle other than an aircraft seals, such as O-rings, may be employed between components of the venting device of the present invention to prevent leakage of gases into the aircraft or vehicle.

A low-friction coating may be provided between the second structural member 19 and the second outlet duct 15 to facilitate relative sliding movement between them as the device reacts to a shock wave and returns to its original position.

The elastomeric sleeve 20 need not be formed from a fluoro-elastomer: silicon rubber, neoprene or other rubbers may be employed. The elastomeric sleeve 20 and/or the bellows duct 23 may be formed as a composite and may include reinforcing fibers, such as carbon fiber or glass fiber.

The internal shape of the flexible sleeve (whether in the form of an elastomeric sleeve 20 or a bellows duct 23) may be circular, oval, square or rectangular, in dependence on the shape of the outlet duct 15 and the ducts or pipes of the remainder of the venting system 7. The end portions of the flexible sleeve may be bonded onto, cured with, or over-molded on the structural members 18, 19, 24. Alternatively, a combination of joining methods may be employed to increase the security of the connection.

One end portion of the flexible sleeve may be fastened or bonded to a wall of the battery pack 6a, such that the sleeve surrounds the burst disc 13. In this variant, the battery pack itself forms one of the rigid structural members.

The burst disc 13 may take the form of a pressure relief valve or other safety valve. The burst disc may be circular, oval or a panel (i.e. rectangular) or have any other suitable geometry. The burst disc is preferably unidirectional but may be bi-directional. The burst disc may be single use, such that it needs to be replaced once activated, or multi-use. The burst disc may have a single bursting membrane or may have multiple membranes.

The structural members 18, 19, 24, may have simple or convoluted shapes. They are shown simply in these drawings as simple, straight-sided components having right-angle joints between the parts of each member. However, they may be made of any suitable shape and configuration having slopes, curves and bends in accordance with the requirements of the venting system and the available space in the aircraft or other vehicle.

The venting device according to the invention is shown as being employed immediately adjacent or close to each battery pack of the electronic storage system. Such venting devices may be employed at other locations in the venting system—for example, close to the exit port near the skin of the aircraft. The venting devices 9a, 9b, 9c employed in a venting system may all be of the type shown in FIG. 3 or may all be of the type shown in FIG. 4. Alternatively, a combination of types of venting device may be utilized.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both, unless the disclosure states otherwise. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

The invention is:

1. A venting device for an energy storage system comprising:
a burst disc;
a fluid flow path including a first outlet duct and a second outlet duct;
a flexible coupling around a junction between the first outlet duct and the second outlet duct; and
a piston seal between one of the first and second outlet ducts and the flexible coupling.

2. The venting device as claimed in claim 1, wherein the piston seal and the flexible coupling are arranged to provide an expansion cavity for gases exiting the burst disc.

3. The venting device as claimed in claim 1, wherein the flexible coupling and the piston seal are arranged for relative sliding movement.

4. The venting device as claimed claim 1, wherein the flexible coupling comprises:
a first rigid structural member associated with the first outlet duct and a second rigid structural member associated with the second outlet duct, and
a flexible sleeve between the first rigid structural member and the second rigid structural member.

5. The venting device as claimed in claim 4, wherein the flexible sleeve comprises a tube of elastomeric material.

6. The venting device as claimed in claim 4, wherein the flexible sleeve comprises a bellows duct.

7. The venting device as claimed in claim 4, wherein the first and second rigid structural members are configured for sliding movement with respect to the outlet ducts.

8. The venting device as claimed in claim 4, wherein the piston seal is attached to the first outlet duct and is arranged to make sliding contact with the second structural member.

9. The venting device as claimed in claim 1, wherein the first and second outlet ducts are arranged along a common axis and the flexible coupling is coaxial with the common axis and is arranged around the first and second outlet ducts.

10. The venting device as claimed in claim 1, wherein the energy storage system comprises a housing including an outlet to the burst disc.

11. An energy storage system comprising:
a battery in a housing, and
the venting device as claimed in claim 1.

12. An energy storage system comprising:
batteries each in a respective housing, and each of the housings includes the venting device as claimed in claim 1.

13. A vehicle comprising the energy storage system as claimed in claim 11.

14. The vehicle as claimed in claim 13, further comprising a venting system comprising at least one duct between the venting device and an exterior surface of the vehicle.

15. The vehicle as claimed in claim 13, wherein the vehicle is an aircraft.

16. An energy storage and vent assembly comprising:
a battery;
a housing containing the battery;
a venting system configured to vent gas from the housing, wherein the venting system includes:
a burst disc aligned within an opening the housing and adjacent the housing;
a fluid flow path including a first outlet duct and a second outlet duct;
a first inlet to the first outlet duct extending round the burst disc and attached to the housing and a first outlet to the first outlet duct, wherein the first outlet duct has a first minimum cross-sectional area;
a second inlet to the second outlet duct in fluid communication with the first outlet to the first outlet duct and a second outlet to the second outlet duct in fluid communication with an exit port of the fuselage, wherein the second outlet duct as a second maximum cross-sectional area smaller than the first minimum cross-sectional area; and
a flexible coupling joining the first outlet duct and the second outlet duct, wherein the first outlet of the first outlet duct and the second inlet to the second outlet duct both open into the flexible coupling,
wherein the flexible coupling includes an annular piston seal having an inner circumference attached to one of the first and second outlet ducts and the flexible coupling, and
wherein the flexible coupling is fixed to a structural member of a fuselage of an aircraft.

17. The energy storage and vent assembly of claim 16, wherein the first outlet duct, the second outlet duct and the flexible coupling are aligned along a common axis.

18. The energy storage and vent assembly of claim 16, wherein the flexible coupling includes a structural member including a neck member attached to an outer surface of the second outlet duct, a shoulder part having an inner circumference joined to the neck member, a sleeve part joined to an outer circumference of the shoulder part and a rim joined to the sleeve part, wherein the rim is fixed to the structural member and an inner surface of the shoulder part is sealed to an outer circumference of the annular piston seal.

19. The energy storage and vent assembly of claim 18, wherein the shoulder part, the sleeve part and the annular piston seal partially define an annular expansion cavity in the flexible coupling.

20. The energy storage and vent assembly of claim 18, wherein the flexible coupling includes an elastomeric tube having a first end attached to the rim and a second end attached to the structural member.
